(19) United States
(12) Patent Application Publication
(10) Pub. No.: US 2024/0104199 A1
(43) Pub. Date: Mar. 28, 2024

(54) SYSTEMS AND METHODS FOR ROBUST SCAN AND UPLOAD CYBER SECURITY PATCH TO EDGE NODE

(71) Applicant: Honeywell International Inc., Charlotte, NC (US)

(72) Inventors: Sridhar Kommisetty RATHNAIAHSETTY, Bangalore (IN); Avinash Nittur VENKATESH, Bangalore (IN); Gagandeep SINGH, Bangalore (IN)

(21) Appl. No.: 18/070,000

(22) Filed: Dec. 21, 2022

(30) Foreign Application Priority Data
Sep. 27, 2022 (IN) 202211055420

(51) Int. Cl. G06F 21/55

(52) U.S. Cl. CPC G06F 21/552; G06F 2221/033

(57) ABSTRACT

Disclosed are methods and systems for monitoring and modifying security modules for identifying cyber-security threats. For instance, a method may include partitioning an edge node of an aircraft into an edge node module and a cyber-security module, recording aircraft data corresponding to the aircraft, the aircraft data including log data and associated information, determining based on the aircraft data, that the aircraft has a ground location and that at least one engine of the aircraft is powered off, based on the determining, connecting at least one wireless interface of the edge node of the aircraft to a Centralized Service hosted on a cloud platform, sending the aircraft data to the Centralized Service, receiving at least one current cyber-security module identified by the Centralized Service based on the aircraft data, and modifying, the cyber-security module based on the received at least one current cyber-security module.

### CROSS-REFERENCE TO RELATED APPLICATION(S)

This application claims the benefit of priority to Indian Patent Application No. 202211055420, filed on Sep. 27, 2022, the entirety of which is incorporated by reference herein.

### TECHNICAL FIELD

Various embodiments of the present disclosure relate generally to monitoring and modifying security modules for identifying cyber-security threats and, more particularly, to systems and methods for monitoring and modifying security modules for identifying cyber-security threats.

### BACKGROUND

Demand has grown for protecting communications systems that are vulnerable to network security threats. As more services become connected through different communication interfaces, such services become more vulnerable to network security threats. Additionally, it can become increasingly challenging to determine potential system security vulnerabilities of such services.

More generally, under current approaches, users may manually determine potential security threats, as well as technological solutions to the potential security threats. However, such approaches may be inefficient, time consuming, and burdensome for the users.

This disclosure is directed to addressing above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for monitoring and modifying security modules for identifying cyber-security threats.

In one aspect, an exemplary embodiment of a method for monitoring and modifying security modules for identifying cyber-security threats is disclosed. The method may include partitioning, by one or more processors, an edge node of an aircraft into an edge node module and a cyber-security module, the edge node module configured to perform an edge node functionality, the cyber-security module configured to monitor for one or more security threats. The method may further include recording, by the one or more processors, aircraft data corresponding to the aircraft, the aircraft data including log data and associated information. The method may further include determining, by the one or more processors, based on the aircraft data, that the aircraft has a ground location and that at least one engine of the aircraft is powered off. The method may further include based on the determining, connecting, by the one or more processors at least one wireless interface of the edge node of the aircraft, to a Centralized Service hosted on a cloud platform. The method may further include sending, by the one or more processors, the aircraft data to the Centralized Service. The method may further include receiving, by the one or more processors, at least one current cyber-security module identified by the Centralized Service based on the aircraft data. The method may further include modifying, by the one or more processors, via the at least one wireless interface, the cyber-security module based on the received at least one current cyber-security module.

In one aspect, a computer system for monitoring and modifying security modules to overcome a cyber-security threat is disclosed. The computer system may include one or more processors, and one or more computer readable storage media storing instructions which, when executed by the one or more processors, cause the one or more processors to perform operations. The operations may include partitioning an edge node of an aircraft into an edge node module and a cyber-security module, the edge node module configured to perform an edge node functionality, the cyber-security module configured to monitor for one or more security threats. The operations may further include recording aircraft data corresponding to the aircraft, the aircraft data including one or more events. The operations may further include determining based on aircraft data and aircraft data, that the aircraft has a ground location and that at least one engine of the aircraft is powered off. The operations may further include based on the determining, connecting at least one wireless interface of the edge node of the aircraft to a Centralized Service hosted on a cloud platform. The operations may further include sending the aircraft data to the Centralized Service. The operations may further include receiving at least one current cyber-security module identified by the Centralized Service based on the aircraft data. The operations may further include modifying via the at least one wireless interface, the cyber-security module based on the received at least one current cyber-security module.

In one aspect, non-transitory computer readable medium storing instructions which, when executed by one or more processors, cause the one or more processors to perform operations for monitoring and modifying security modules to overcome a cyber-security threat is disclosed. The operations may include partitioning an edge node of an aircraft into an edge node module and a cyber-security module, the edge node module configured to perform an edge node functionality, the cyber-security module configured to monitor for one or more security threats. The operations may further include recording aircraft data corresponding to the aircraft, the aircraft data including one or more events. The operations may further include determining based on the aircraft data, that the aircraft has a ground location and that at least one engine of the aircraft is powered off. The operations may further include based on the determining, connecting at least one wireless interface of the edge node of the aircraft to a Centralized Service hosted on a cloud platform. The operations may further include sending the aircraft data to the Centralized Service. The operations may further include receiving at least one current cyber-security module identified by the Centralized Service based on the aircraft data. The operations may further include modifying via the at least one wireless interface, the cyber-security module based on the received at least one current cyber-security module.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary environment that may be utilized with techniques presented herein, according to one or more embodiments.

FIG. 2 depicts an exemplary system flow for monitoring and modifying security modules for identifying cyber-security threats, according to one or more embodiments.

FIG. 3 depicts a flowchart of an exemplary method for monitoring and modifying security modules for identifying cyber-security threats, according to one or more embodiments.

FIG. 4 depicts an exemplary system that may execute techniques presented herein.

### DETAILED DESCRIPTION OF EMBODIMENTS

According to certain aspects of the disclosure, methods and systems are disclosed for monitoring and modifying security modules for identifying cyber-security threats. Conventional techniques may not be suitable because conventional techniques may not allow for the automation of identifying potential security threats in aircraft data, identifying security threat solutions, and implementing such security threat solutions. Accordingly, improvements in technology relating to monitoring and modifying security modules for identifying cyber-security threats are needed.

Demand has grown for protecting systems that may be vulnerable to network security threats. As more services become connected through different communication interfaces, such services become more vulnerable to network security threats. Additionally, it can become increasingly challenging to determine potential system security vulnerabilities. More generally, under current approaches, users may manually determine potential security threats, as well as technological solutions to such potential security threats. However, such approaches may be inefficient, time consuming, and burdensome for the users. As a result, there is a demand to automatically capture data that may indicate potential security vulnerabilities, as well as automatically identify cyber-security solutions to such potential security vulnerabilities. Additionally, there is also a demand to automatically evaluate the health of a system, in order to determine whether additional modifications need to be made to the system to keep such system current.

Advantages of such a solution may include increasing the efficiency and accuracy of identifying potential security threats and solutions, reducing the maintenance burden of the system by automatically deploying new cyber-security solutions, as well as utilizing the recorded data for predictive analysis to improve the identification of potential security threats and solutions.

The systems and methods disclosed herein relate to monitoring and modifying security modules for identifying cyber-security threats. The systems and methods may include partitioning an edge node of an aircraft into an edge node module and a cyber-security module, the edge node module configured to perform an edge node functionality, the cyber-security module configured to monitor for one or more security threats. The systems and methods may further include recording aircraft data corresponding to the aircraft, the aircraft data including one or more events. The systems and methods may further include determining based on the aircraft data, that the aircraft has a ground location and that at least one engine of the aircraft is powered off. The systems and methods may further include, based on the determining, connecting at least one wireless interface of the edge node of the aircraft to a Centralized Service hosted on a cloud platform. The systems and methods may further include sending the aircraft data to the Centralized Service. The systems and methods may further include receiving at least one current cyber-security module identified by the Centralized Service based on the aircraft data. The systems and methods may further include modifying via the at least one wireless interface, the cyber-security module based on the received at least one current cyber-security module.

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus. In this disclosure, relative terms, such as, for example, “about,” “substantially,” “generally,” and “approximately” are used to indicate a possible variation of ±10% in a stated value. The term “exemplary” is used in the sense of “example” rather than “ideal.” As used herein, the singular forms “a,” “an,” and “the” include plural reference unless the context dictates otherwise.

While this disclosure describes the systems and methods with reference to monitoring and modifying security modules to overcome a cyber-security threat in an edge node, it should be appreciated that the present systems and methods are applicable to monitoring and modifying security modules to overcome a cyber-security threat in any piece of technology.

### Exemplary Environment

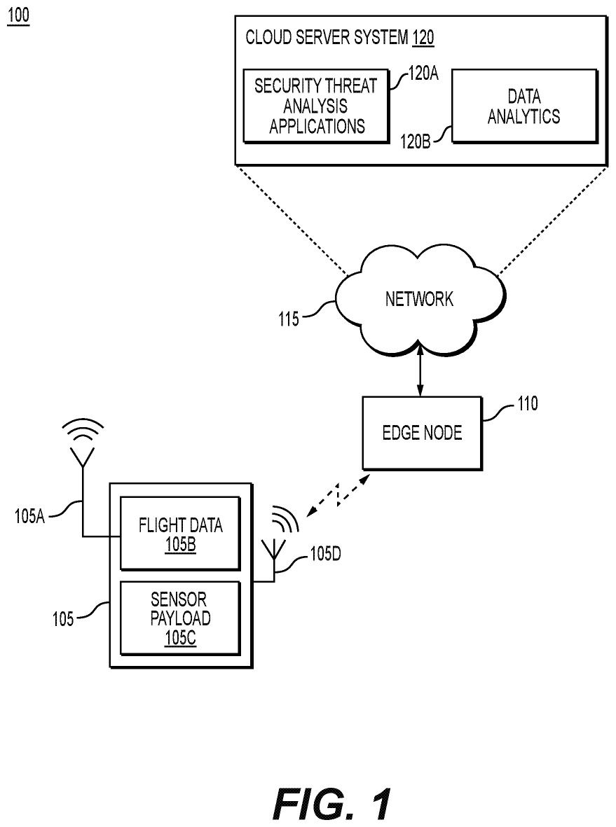

FIG. 1 depicts an exemplary environment 100 that may be utilized with techniques presented herein. The system 100 is illustrative of how an aircraft 105, edge node 110, and a cloud server system 120 distribute avionics processing to operate an aircraft 105.

Onboard GNSS, inertial navigation system (IRS), visual sensors (e.g., cameras, LiDAR, etc.), and radio aids (e.g., transponders, radar, etc.) may contribute to situational awareness and contribute to maintaining safety of aircraft, such as aircraft 105. Piloted systems may have line replaceable units (LRUs) carried on-board and/or attached to aircraft 105 to process these inputs and help a pilot ensure safe aviation and navigation. Additionally, or alternatively, piloted systems may have line-replaceable modules (LRM), which may be used in Inter Modular Architecture (IMA) in avionics, on the aircraft 105.

The aircraft 105 may include a receiver system 105A, a processor executing a distributed processing program to execute a distributed processing process (with a memory storing flight data 105B, payload data, and the distributed processing program), a sensor payload 105C, and/or a communication system 105C. The processor may be a part of, or the processor may be separate from, the receiver system 105A and/or the communication system 105D.

The receiver system 105A may perform the same functions as a GPS system. For instance, the receiver system 105A may receive signals from one or more satellites, and determine a position of the aircraft 105. Moreover, the receiver system 105A or the processor of the aircraft 105 may determine a signal strength based on the received signals.

The processor of the aircraft 105, in accordance with the sensor/payload data management logic, may store the flight data 105B in the memory. The flight data 105B may be stored in the memory for a flight data buffer period. The flight data buffer period may be: a set period of time, such as a day, an hour or multiple hours, a minute or minutes, or seconds; an entire flight or segments thereof such as between waypoints; more than one flight, etc. The flight data 105B may include the received signals and/or the determined position. The flight data 105B may also include other flight relevant data derived from the signals (e.g., signal strength, speed, velocity, acceleration, altitude, etc.) and/or the navigation information (or components thereof) from the on-board aircraft navigation systems.

The sensor payload 105C may be any one or more of the aircraft systems, such as camera(s), edge sensors, one or more transponder(s), on-board aircraft navigation systems, or sub-components thereof, etc. The sensor payload 105C may obtain payload data from the one or more of the aircraft systems. The processor of the aircraft 105, in accordance with the sensor/payload data management logic, may store the payload data on-board the aircraft 105 in the memory. The payload data may be stored in the memory for a payload buffer period. The payload buffer period may be the same or different from the flight data buffer period discussed above.

The processor of the aircraft 105, in accordance with the sensor/payload data management logic, may store the flight data 105B and the payload data on-board the aircraft 105 for the flight data buffer period and the payload buffer period, respectively, and then control the communication system 105D to transmit the stored flight data 105B/stored payload data to the edge node 110. For instance, the transmissions of the stored flight data 105B/stored payload data may be data messages to the edge node 110. The communications system 105D may communicate wirelessly with the edge node 110 using general wireless standards, such Wi-Fi or 5G.

The aircraft 105 may offload certain functions to the edge node 110. For instance, the aircraft 105 may include the actuation systems and sensors/payload. The aircraft 105 may host time sensitive functionality, such as sensor/payload data management logic and control logic. The edge node 110 may host processing, such as aircraft management logic, traffic management logic, mission planning logic, navigation logic, etc.

The edge node 110 may provide the required capacity and other capabilities to support avionics applications, as well as be in communication with the LRUs and/or LRMs. Additionally, the edge node 110 may store data received from the avionics applications and/or the LRUs and/or LRMs. The edge node 110 may receive messages from the aircraft 105 and relay the messages to the cloud server system 120. The edge node 110 may receive and store the messages from the aircraft 105 in log files. As an example, the aircraft 105 may transmit, in real-time, flight and navigation parameters (e.g., GPS position and environment data, such as weather or obstacle detection by the camera(s) 316), engine data, control systems data, and environmental system data, to the edge node 110. The edge node 110 may then store the received data. The edge node 110 may also send, via network 115, the received data to the cloud server system 120 for analysis.

The cloud server system 120 may host applications that may analyze edge node log data (e.g., LRU data and/or LRM data) to determine cyber security threats, as well as determine technical solutions to such cyber security threats. Additionally, the cloud server system 120 may host applications (e.g., security threat applications 120A) that may determine whether the edge node 110 includes current security applications, or whether the edge node 110 needs more current security applications. The cloud server system 120 may also include a data analytics module 1208 that may perform different analysis on security threat determinations, solutions, and outcomes.

In various embodiments, the network 115 may be a wide area network (“WAN”), a local area network (“LAN”), a personal area network (“PAN”), or the like. In some embodiments, network 115 includes the Internet, and information and data provided between various systems occurs online. “Online” may mean connecting to or accessing source data or information from a location remote from other devices or networks coupled to the Internet. Alternatively, “online” may refer to connecting or accessing a network (wired or wireless) via a mobile communications network or device. The Internet is a worldwide system of computer networks—a network of networks in which a party at one computer or other device connected to the network can obtain information from any other computer and communicate with parties of other computers or devices. The most widely used part of the Internet is the World Wide Web (often-abbreviated “WWW” or called “the Web”). A “website page” generally encompasses a location, data store, or the like that is, for example, hosted and/or operated by a computer system so as to be accessible online, and that may include data configured to cause a program such as a web browser to perform operations such as send, receive, or process data, generate a visual display and/or an interactive interface, or the like.

### Exemplary System for Monitoring and Modifying Security Modules

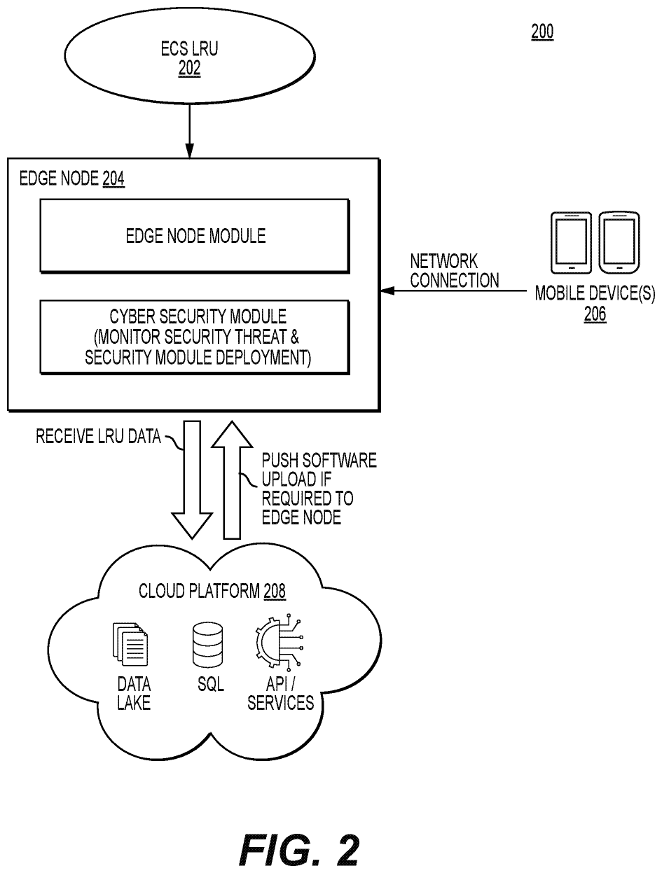

FIG. 2 illustrates an exemplary system 200 for monitoring and modifying security modules for identifying cyber-security threats, according to one or more embodiments. Notably, process 200 may be performed by one or more processors of a server that is in communication with one or more user devices and the cloud platform via a network. However, it should be noted that process 200 may be performed by any of the displayed components.

The exemplary system may include an environmental control system (ECS) line-replaceable unit (LRU) 202. The ECS LRU 202 may collect LRU data, which may include log data, from other components of the aircraft. The LRU data may include engine data, control systems data, sensor data, environmental system data, flight and navigation parameters, and the like. Additionally, or alternatively, LRM data may be collected in addition to (or alternate from) the LRU data. The LRM data my include engine data, control systems data, sensor data, environmental system data, flight and navigation parameters, and the like.

The exemplary system may include an edge node 204 that may be partitioned into an edge node module and a cyber-security module. The edge node module may be configured to perform edge node functionality, such as recording and storing log data. For example, the ECS LRU 202 may send the LRU data to the edge node module, where the edge node module may record and store the log data. The cyber-security module may monitor for security threats and security module deployment.

The exemplary process may include one or more mobile devices 206 that may communicate with the edge node module. For example, the mobile devices 206 may upload additional log data to the edge node module for the edge node module to record and store. Additionally, the mobile devices 206 may modify the LRU data that was previously recorded and stored by the edge node module.

The exemplary system may include a cloud platform 208. The cloud platform 208 may include components (e.g., Data Lake, SQL, and/or API/Services) for receiving and analyzing the LRU data sent from the edge node module. For example, the cloud platform 208 may analyze the LRU data to determine whether the LRU data identifies any security threats. The cloud platform 208 may perform additional analysis to determine whether any possible external security threats (not identified in the LRU data) exist. In either case, the cloud platform 208 may identify one or more security modules to prevent against the identified or possible security threats. Additionally, or alternatively, the cloud platform 208 may analyze the LRU data to determine whether the security module needs a security module update to keep the security modules current. Upon identifying a security module for the cyber-security module, the cloud platform 208 may then push the security module to the cyber-security module. The cyber-security module may then apply the security module to prevent against a possible security threat.

Although FIG. 2 shows example blocks of exemplary process 200, in some implementations, the exemplary process 200 may include additional blocks, fewer blocks, different blocks, or differently arranged blocks than those depicted in FIG. 2. Additionally, or alternatively, two or more of the blocks of the exemplary process 200 may be performed in parallel.

### Exemplary Method for Monitoring and Modifying Security Modules

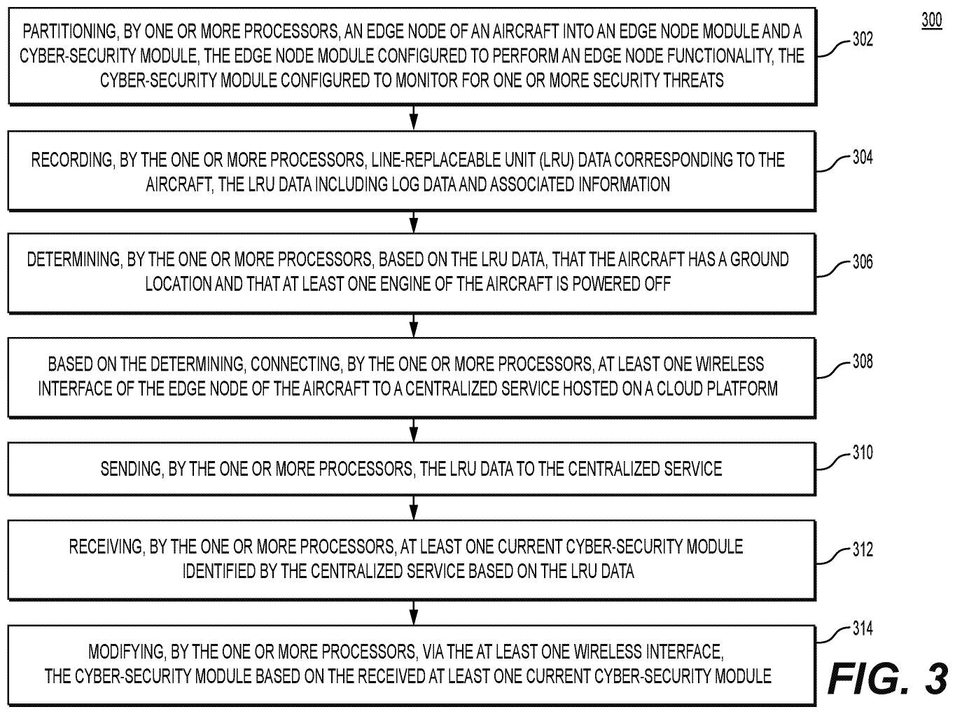

FIG. 3 illustrates an exemplary method 300 for monitoring and modifying security modules for identifying cyber-security threats, according to one or more embodiments. Notably, method 300 may be performed by one or more processors of a server that is in communication with one or more user devices and other external system(s) via a network. However, it should be noted that method 300 may be performed by any one or more of the server, one or more user devices, or other external systems.

The method may include partitioning, by one or more processors, an edge node of an aircraft into an edge node module and a cyber-security module, the edge node module configured to perform an edge node functionality, the cyber-security module configured to monitor for one or more security threats (Step 302). The partitioning may be performed automatically by the system or the partitioning may be performed manually by a user. The edge node may be located on the aircraft. The edge node may include a device with at least one embedded module. The edge node module may be configured to perform an edge node functionality, such as recording and storing data. The cyber-security module may include one or more security modules that may be configured to address security threats and/or prevent against potential security events. Additionally, the cyber-security module may be isolated from the edge node module. For example, the cyber-security module may not have access to the data stored in the edge node module. This may prevent against a potential security attack accessing the data.

The method may also include recording, by the one or more processors, aircraft data corresponding to the aircraft, the aircraft data including log data and associated information (Step 304). For example, the edge node module may record the aircraft data, where the edge node module may encode the aircraft data and store the aircraft data. The aircraft data may include line-replaceable unit (LRU) data and/or line-replaceable module (LRM) data. The aircraft data may include log data and associated information. The log data may include one or more events corresponding to the aircraft. Additionally, the associated information may include details associated with the log data, such as the event location, event time, and the like. The aircraft data may include engine data, control systems data, sensor data, environmental system data, flight and navigation parameters, and the like. In some embodiments, the aircraft data may be received from components of the aircraft in real-time, whereas in other embodiments, the aircraft data may be received at different time intervals (e.g., between each flight leg).

The method may also include determining, by the one or more processors, based on the aircraft data, that the aircraft has a ground location and that at least one engine of the aircraft is powered off (Step 306). In some embodiments, the edge node module may perform the determining. The determining may include analyzing the aircraft data to determine a current state of the aircraft. The state may include one or more of: an off state, an on state, and the like. The determining may also include analyzing the aircraft data to determine a current location of the aircraft. The current location may include a ground location, an airborne location, and the like. In some embodiments, the current location may include exact GPS coordinates of the aircraft.

The method may also include, based on the determining, connecting, by the one or more processors, at least one wireless interface of the edge node of the aircraft to a Centralized Service hosted on a cloud platform (Step 308). For example, upon determining that the aircraft is powered off on the ground, the edge node may connect to a Centralized Service that is hosted on a cloud platform. The connecting may occur via a wireless interface of the edge node. Example wireless interfaces may include Wi-Fi, Bluetooth, other data links, and the like.

The method may also include sending, by the one or more processors, the aircraft data to the Centralized Service (Step 310). Upon connecting to the Centralized Service, the edge node module may send the aircraft data to the Centralized Service. The Centralized Service may be configured to store and analyze the aircraft data to determine at least one security threat. The at least one current cyber-security module may correspond to the at least one security threat. For example, the Centralized Service may identify the at least one current cyber-security module as addressing the at least one security threat. In some embodiments, the Centralized Service may have determined external security threats and identified at least one current cyber-security module that may prevent against the external security threats. By way of further example, the Centralized Service may select the at least one current cyber-security module in response to determining a health level of the cyber-security module based on the aircraft data. For example, the health level may indicate that the cyber-security module is out of date.

The method may also include receiving, by the one or more processors, at least one current cyber-security module identified by the Centralized Service based on the aircraft data (Step 312). For example, as discussed above, the Centralized Service may be configured to identify the at least one current cyber-security module in response to analyzing the aircraft data.

The method may also include modifying, by the one or more processors, via the at least one wireless interface, the cyber-security module based on the received at least one current cyber-security module (Step 314). Upon receiving the at least one current cyber-security module, the cyber security module and/or the edge node module may apply the received at least one current cyber-security module to the cyber security module. The configurations of the cyber-security module may be modified in response to the application.

In some embodiments, the method may also include determining, by the one or more processors, that the modifying the cyber-security module failed. For example, the edge node may determine that the at least one current cyber-security module was only partially applied to the cyber-security module. The method may further include reinstating, by the one or more processors, the cyber-security module to a state corresponding to the cyber-security module before the modifying. In response to determining that the modifying failed, the edge node may reinstate the cyber-security module to a previous state. For example, the cyber-security may periodically save its state (e.g., a snapshot) to reflect the configurations at a particular point in time. As a result, the edge node may be able to select a particular state to reinstate the cyber-security module.

Although FIG. 3 shows example blocks of exemplary method 300, in some implementations, the exemplary method 300 may include additional blocks, fewer blocks, different blocks, or differently arranged blocks than those depicted in FIG. 3. Additionally, or alternatively, two or more of the blocks of the exemplary method 300 may be performed in parallel.

### Exemplary Device

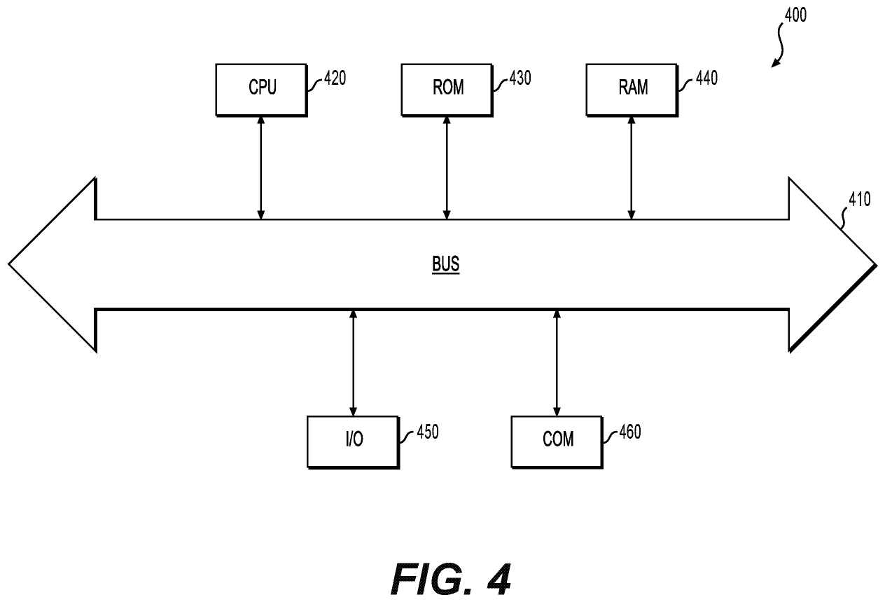

FIG. 4 is a simplified functional block diagram of a computer 400 that may be configured as a device for executing the methods of FIGS. 2-3, according to exemplary embodiments of the present disclosure. For example, device 400 may include a central processing unit (CPU) 420. CPU 420 may be any type of processor device including, for example, any type of special purpose or a general-purpose microprocessor device. As will be appreciated by persons skilled in the relevant art, CPU 420 also may be a single processor in a multi-core/multiprocessor system, such system operating alone, or in a cluster of computing devices operating in a cluster or server farm. CPU 420 may be connected to a data communication infrastructure 410, for example, a bus, message queue, network, or multi-core message-passing scheme.

Device 400 also may include a main memory 440, for example, random access memory (RAM), and also may include a secondary memory 430. Secondary memory 430, e.g., a read-only memory (ROM), may be, for example, a hard disk drive or a removable storage drive. Such a removable storage drive may comprise, for example, a floppy disk drive, a magnetic tape drive, an optical disk drive, a flash memory, or the like. The removable storage drive in this example reads from and/or writes to a removable storage unit in a well-known manner. The removable storage unit may comprise a floppy disk, magnetic tape, optical disk, etc., which is read by and written to by the removable storage drive. As will be appreciated by persons skilled in the relevant art, such a removable storage unit generally includes a computer usable storage medium having stored therein computer software and/or data.

In alternative implementations, secondary memory 430 may include other similar means for allowing computer programs or other instructions to be loaded into device 400. Examples of such means may include a program cartridge and cartridge interface (such as that found in video game devices), a removable memory chip (such as an EPROM, or PROM) and associated socket, and other removable storage units and interfaces, which allow software and data to be transferred from a removable storage unit to device 400.

Device 400 also may include a communications interface (“COM”) 460. Communications interface 460 allows software and data to be transferred between device 400 and external devices. Communications interface 460 may include a modem, a network interface (such as an Ethernet card), a communications port, a PCMCIA slot and card, or the like. Software and data transferred via communications interface 460 may be in the form of signals, which may be electronic, electromagnetic, optical, or other signals capable of being received by communications interface 460. These signals may be provided to communications interface 460 via a communications path of device 400, which may be implemented using, for example, wire or cable, fiber optics, a phone line, a cellular phone link, an RF link or other communications channels.

The hardware elements, operating systems and programming languages of such equipment are conventional in nature, and it is presumed that those skilled in the art are adequately familiar therewith. Device 400 also may include input and output ports 450 to connect with input and output devices such as keyboards, mice, touchscreens, monitors, displays, etc. Of course, the various server functions may be implemented in a distributed fashion on a number of similar platforms, to distribute the processing load. Alternatively, the servers may be implemented by appropriate programming of one computer hardware platform.

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

Reference to any particular activity is provided in this disclosure only for convenience and not intended to limit the disclosure. A person of ordinary skill in the art would recognize that the concepts underlying the disclosed devices and methods may be utilized in any suitable activity. The disclosure may be understood with reference to the following description and the appended drawings, wherein like elements are referred to with the same reference numerals.

It should be appreciated that in the above description of exemplary embodiments of the invention, various features of the invention are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this invention.

Furthermore, while some embodiments described herein include some but not other features included in other embodiments, combinations of features of different embodiments are meant to be within the scope of the invention, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the invention, and it is intended to claim all such changes and modifications as falling within the scope of the invention. For example, functionality may be added or deleted from the block diagrams and operations may be interchanged among functional blocks. Steps may be added or deleted to methods described within the scope of the present invention.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations are possible within the scope of the disclosure. Accordingly, the disclosure is not to be restricted except in light of the attached claims and their equivalents.

What is claimed is:

1. A computer-implemented method for monitoring and modifying security modules for identifying cyber-security threats, the method comprising:
partitioning, by one or more processors, an edge node of an aircraft into an edge node module and a cyber-security module, the edge node module configured to perform an edge node functionality, the cyber-security module configured to monitor for one or more security threats;
recording, by the one or more processors, aircraft data corresponding to the aircraft, the aircraft data including log data and associated information;
determining, by the one or more processors, based on the aircraft data, that the aircraft has a ground location and that at least one engine of the aircraft is powered off;
based on the determining, connecting, by the one or more processors at least one wireless interface of the edge node of the aircraft to a Centralized Service hosted on a cloud platform;
sending, by the one or more processors, the aircraft data to the Centralized Service;
receiving, by the one or more processors, at least one current cyber-security module identified by the Centralized Service based on the aircraft data; and
modifying, by the one or more processors, via the at least one wireless interface, the cyber-security module based on the received at least one current cyber-security module.

2. The computer-implemented method of claim 1, wherein the Centralized Service selects the at least one current cyber-security module in response to determining a health level of the cyber-security module based on the aircraft data.

3. The computer-implemented method of claim 2, wherein the health level indicates that the cyber-security module is out of date.

4. The computer-implemented method of claim 1, wherein the cyber-security module is isolated from the edge node module.

5. The computer-implemented method of claim 1, the method further comprising:
determining, by the one or more processors, that the modifying the cyber-security module failed; and
reinstating, by the one or more processors, the cyber-security module to a state corresponding to the cyber-security module before the modifying.

6. The computer-implemented method of claim 1, wherein the edge node includes a device with at least one embedded module.

7. The computer-implemented method of claim 1, wherein the Centralized Service is configured to analyze the aircraft data to determine at least one security threat.

8. The computer-implemented method of claim 7, wherein the at least one current cyber-security module corresponds to the at least one security threat.

9. The computer-implemented method of claim 1, wherein the aircraft data includes line-replaceable unit (LRU) data or line-replaceable module (LRM) data.

10. A computer system for monitoring and modifying security modules to overcome a cyber-security threat, a server configured to:
one or more processors; and
one or more computer readable storage media storing instructions which, when executed by the one or more processors, cause the one or more processors to perform operations comprising:
partitioning an edge node of an aircraft into an edge node module and a cyber-security module, the edge node module configured to perform an edge node functionality, the cyber-security module configured to monitor for one or more security threats;
recording aircraft data corresponding to the aircraft, the aircraft data including one or more events;
determining based on the aircraft data, that the aircraft has a ground location and that at least one engine of the aircraft is powered off;
based on the determining, connecting at least one wireless interface of the edge node of the aircraft to a Centralized Service hosted on a cloud platform;
sending the aircraft data to the Centralized Service;
receiving at least one current cyber-security module identified by the Centralized Service based on the aircraft data; and
modifying via the at least one wireless interface, the cyber-security module based on the received at least one current cyber-security module.

11. The computer system of claim 10, wherein the Centralized Service selects the at least one current cyber-security module in response to determining a health level of the cyber-security module based on the aircraft data.

12. The computer system of claim 11, wherein the health level indicates that the cyber-security module is out of date.

13. The computer system of claim 10, wherein the aircraft data includes line-replaceable unit (LRU) data or line-replaceable module (LRM) data.

14. The computer system of claim 10, wherein the cyber-security module is isolated from the edge node module.

15. The computer system of claim 10, the operations further comprising:
determining that the modifying the cyber-security module failed; and
reinstating the cyber-security module to a state corresponding to the cyber-security module before the modifying.

16. The computer system of claim 10, wherein the edge node includes a device with at least one embedded module.

17. A non-transitory computer readable medium storing instructions which, when executed by one or more processors, cause the one or more processors to perform operations for monitoring and modifying security modules to overcome a cyber-security threat, the operations comprising:
partitioning an edge node of an aircraft into an edge node module and a cyber-security module, the edge node module configured to perform an edge node functionality, the cyber-security module configured to monitor for one or more security threats;
recording aircraft data corresponding to the aircraft, the aircraft data including one or more events;
determining based on the aircraft data, that the aircraft has a ground location and that at least one engine of the aircraft is powered off;
based on the determining, connecting at least one wireless interface of the edge node of the aircraft to a Centralized Service hosted on a cloud platform;
sending the aircraft data to the Centralized Service;
receiving at least one current cyber-security module identified by the Centralized Service based on the aircraft data; and
modifying via the at least one wireless interface, the cyber-security module based on the received at least one current cyber-security module.

18. The non-transitory computer readable medium of claim 17, wherein the Centralized Service selects the at least one current cyber-security module in response to determining a health level of the cyber-security module based on log data and associated information.

19. The non-transitory computer readable medium of claim 17, wherein the Centralized Service is configured to analyze the aircraft data to determine at least one security threat.

20. The non-transitory computer readable medium of claim 17, wherein the aircraft data includes line-replaceable unit (LRU) data or line-replaceable module (LRM) data.
